(19) United States
(12) Patent Application Publication
(10) Pub. No.: US 2019/0060766 A1
(43) Pub. Date: Feb. 28, 2019

(54) SYSTEMS AND METHODS OF PERSISTENT, USER-ADAPTED PERSONAS

(71) Applicant: SixtyFive02, Inc., Oakland, CA (US)

(72) Inventors: Michael George Perry, Oakland, CA (US); Chingchi Billy Hsu, Shanghai (CN)

(21) Appl. No.: 16/109,535

(22) Filed: Aug. 22, 2018

Related U.S. Application Data
(60) Provisional application No. 62/550,067, filed on Aug. 25, 2017.

(51) Int. Cl. A63F 13/825; A63F 13/56; A63F 13/58; G06F 15/18

(52) U.S. Cl. CPC A63F 13/825; G06F 15/18; A63F 13/58; A63F 13/56

(57) ABSTRACT

Systems and methods of creating highly personalized personas are described in this application. Personas of the inventive subject matter are capable of learning new behaviors according to the users that control the personas. When a persona learns a new behavior, that behavior can then be accessed by other personas, creating a shared, group knowledge. Personas can also continue to exist in a persistent environment (e.g., a game word or otherwise) even after a user has ceased to control the user (e.g., by logging off or walking away from the controls). In some embodiments, personas can be used as personal digital assistants that are capable of learning user preferences over time based on both the actions and activities of that user and also based on the actions and activities of other users with their own personas.

### FIELD OF THE INVENTION

The field of the invention is user-adapted avatars that exist in a persistent, virtual environment.

### BACKGROUND

The background description includes information that may be useful in understanding the present invention. It is not an admission that any of the information provided in this application is prior art or relevant to the presently claimed invention, or that any publication specifically or implicitly referenced is prior art.

Many simulation-based games in the past have made efforts to bring non-user characters to life. For example, games like the Sims include simulated personas that can be controlled to interact with other simulated personas. But past efforts to bring simulation-based games to life have failed to appreciate improvements in computing techniques that can improve how virtual personas are simulated and how they can interact with users and other personas.

Moreover, personal digital assistants often function by using a persona (e.g., Siri) that a user interacts with on a regular basis. For example, when a user needs to set a reminder, a verbal inquiry can be registered with the digital assistant and the digital assistant can react accordingly (e.g., to set a reminder). But these systems fail to appreciate advancements in computing that can facilitate dynamically developing personas that are highly customized to their users.

It has yet to be appreciated that existing and newly developed computing techniques can be applied to simulation games to bring to life personas within those games to a greater degree than previously possible.

Thus, there is still a need in the art for improve methods of managing persistent, user-adapted personas.

### SUMMARY OF INVENTION

In one aspect of the inventive subject matter, a system for developing an avatar that is unique to a user is contemplated. The system includes a server that is configured to: operate a persistent game world in which avatars can exist and interact; maintain an avatar database that stores the avatar and learned avatar behaviors; operate a learning engine, wherein the persistent game world, the avatar database, and the learning engine are informationally coupled; accept network connections, wherein, when a network connection is established with a computing device controlled by the user and upon establishing the network connection the user is given access to the avatar that is stored in the avatar database; via the learning engine, learn an avatar behavior using information related to at least one action of the user when the user encounters a situation within the persistent game world; update the avatar database to include the avatar behavior; and after the user terminates the network connection, autonomously operate the avatar within the persistent game world using the avatar behavior.

In some embodiments, the at least one action of the user within the persistent game world comprises at least one of text-based and voice-based chat with other users' avatars, and the avatar behavior comprises a speech pattern of the user.

In some embodiments, the at least one action of the user within the persistent game world comprises avatar pathfinding, and the avatar behavior comprises a user's pathfinding preference.

In some embodiments, the server is further configured to query the avatar database when a second user in control of a second avatar encounters a similar situation to the situation that led to the avatar behavior being learned and to allow the second avatar to use the avatar behavior.

In another aspect of the inventive subject matter, a method of developing an avatar that is unique to a user is contemplated. The method includes the steps of: using at least one server to operate a persistent game world in which avatars can exist and interact; storing an avatar database on the server, wherein the avatar database stores the avatar and learned avatar behaviors; operating a learning engine, wherein the persistent game world, the avatar database, and the learning engine are informationally coupled; establishing, by the at least one server, a network connection with a computing device controlled by the user, wherein the user is given access to the avatar that is stored in the avatar database; learning, via the learning engine, an avatar behavior using information related to at least one action of the user when the user encounters a situation within the persistent game world; updating the avatar database to include the avatar behavior; and using at least the avatar behavior to autonomously operate the avatar within the persistent game world after the user terminates the network connection.

In some embodiments, the at least one action of the user within the persistent game world comprises at least one of text-based and voice-based chat with other users' avatars, and the avatar behavior comprises a speech pattern of the user. In some embodiments, the at least one action of the user within the persistent game world comprises avatar pathfinding, and the avatar behavior comprises a user's pathfinding preference.

In some embodiments, the method can include the additional steps of querying the avatar database when a second user in control of a second avatar encounters a similar situation to the situation that led to the avatar behavior being learned and allowing the second avatar to use the avatar behavior.

In another aspect of the inventive subject matter, a method of developing a personal assistant that is unique to a user is contemplated. The method includes the steps of: using at least one server to operate a persistent virtual environment in which personal assistants can exist and interact; storing a personal assistant database on the server, wherein the personal assistant database stores the personal assistant and learned personal assistant behaviors; operating a learning engine, wherein the persistent virtual environment, the personal assistant database, and the learning engine are informationally coupled; establishing, by the at least one server, a network connection with a computing device controlled by the user, wherein the user is given access to the personal assistant that is stored in the personal assistant database; learning, via the learning engine, a personal assistant behavior using information related to at least one action of the user; updating the personal assistant database to include the personal assistant behavior; and using at least the personal assistant behavior to autonomously operate the personal assistant within the persistent virtual environment after the user terminates the network connection.

In some embodiments, the at least one action of the user within the persistent virtual environment comprises an instruction from the user to the personal assistant, and the personal assistant behavior comprises a response to the instruction. In some embodiments, the at least one action of the user within the persistent virtual environment comprises talking to the personal assistant, and the personal assistant behavior comprises a user's speech patterns.

In some embodiments, the method includes the additional steps of querying the personal assistant database when a second user in control of a second personal assistant encounters a similar situation to the situation that led to the personal assistant behavior being learned and allowing the second personal assistant to use the personal assistant behavior.

### BRIEF DESCRIPTION OF THE DRAWING

FIG. 1 shows n users connected to a persistent environment via a network interface to enable interaction with personas.

FIG. 2 shows n−1 users connected to a persistent environment via a network interface to enable interaction with personas, with one of the personas acting in the absence of human direction.

FIG. 3 is a flow chart describing how user-controlled personas can become customized to a user.

FIG. 4 is a flow chart describing a persona's ability to continue to remain available for interaction with other users when that persona's user has logged off.

FIG. 5 is a flow chart describing how a user's persona can use information gathered by other personas to know, and improve on, how to handle certain situations.

FIG. 6 shows examples of how systems and methods of the inventive subject matter can be used.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

In a broad sense, the inventive subject matter is directed toward improved simulation of virtual personas (e.g., personalized avatars) by enabling user-created personas that persist in a virtual environment even after the user has ceased interacting with the persona (e.g., even after a user has logged off of a game, locked their phone, etc., the persona continues to exist and interact in the virtual environment). It is contemplated that the inventive subject matter can be extended into the fields of, for example, personal digital assistants (e.g., personas of the inventive subject matter can function similar to Siri, Google Assistant, etc.) and online gaming (e.g., game avatars and other playable characters). It is additionally contemplated that implementations of the inventive subject matter facilitate communication and sharing of information between different personas. Thus, a particular persona can belong to a particular user, and each persona is customized according to how the persona's user interacts with it. But each persona is also capable of using the shared experiences of other user-created personas to learn or gather an understanding of how to handle new situations.

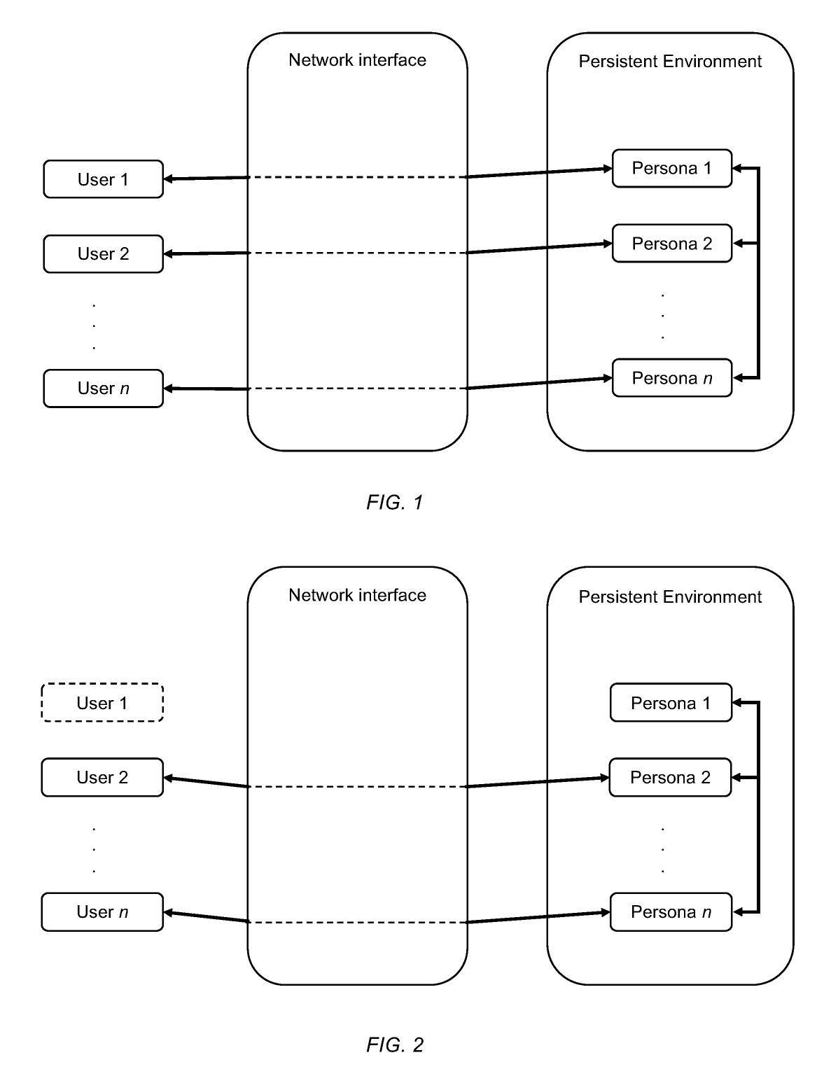

FIG. 1 shows users 1 through n connected to a persistent environment (e.g., a game world) via a network interface so that each user can control their own user-created persona. In some embodiments, the persistent environment can be a persistent environment with a complete and interactive environment that users can navigate with their personas, while in others it describes a persistent space (either a visually represented environment or a virtual construct that has no visual representation) that facilitates interaction between personas. It also shows that, within the persistent environment, each of the different user-created personas is capable of communicating and interacting with other personas. Communication and interaction with other personas can occur by virtue of user-induced interaction, or it can occur in such a way that the interactions are not visible to users. Interactions are discussed in more detail below.

FIG. 2 shows users 2 through n, as shown in FIG. 1, but with User 1 disconnected from the game. Despite User 1's disconnected status, FIG. 2 shows that Persona 1 (the persona corresponding to User 1) is still available for interaction.

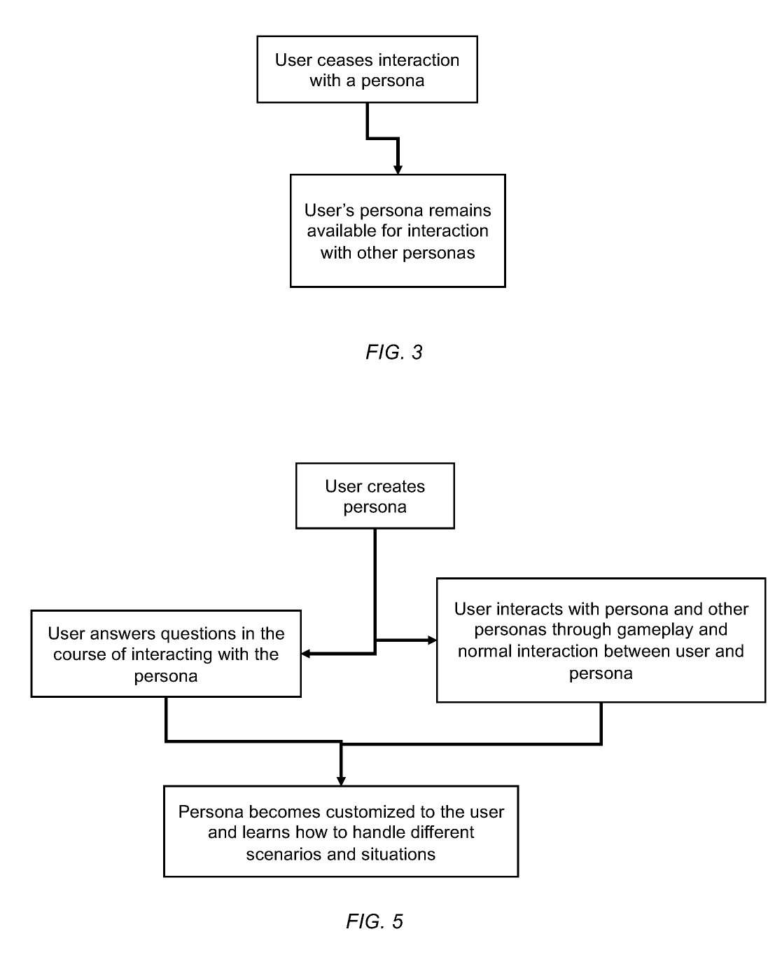

Several types of interactions between personas are contemplated. In some instances, personas can interact with one another by virtue of user control. For example, in FIG. 1, if User 1 directs Persona 1 to interact with Persona 2, which is controlled by User 2, then the resulting interaction is considered a “direct” interaction. Another form of direct interaction can occur when one user is logged off or not actively controlling a persona. For example, in FIG. 2, if Persona 2 (controlled by User 2) is directed by User 2 to interact with Persona 1 (which would normally be controlled by User 1 but for, for example, User 1's disconnected status), then the resulting interaction is also considered a “direct” interaction. This form of direct interaction is demonstrated in FIG. 3.

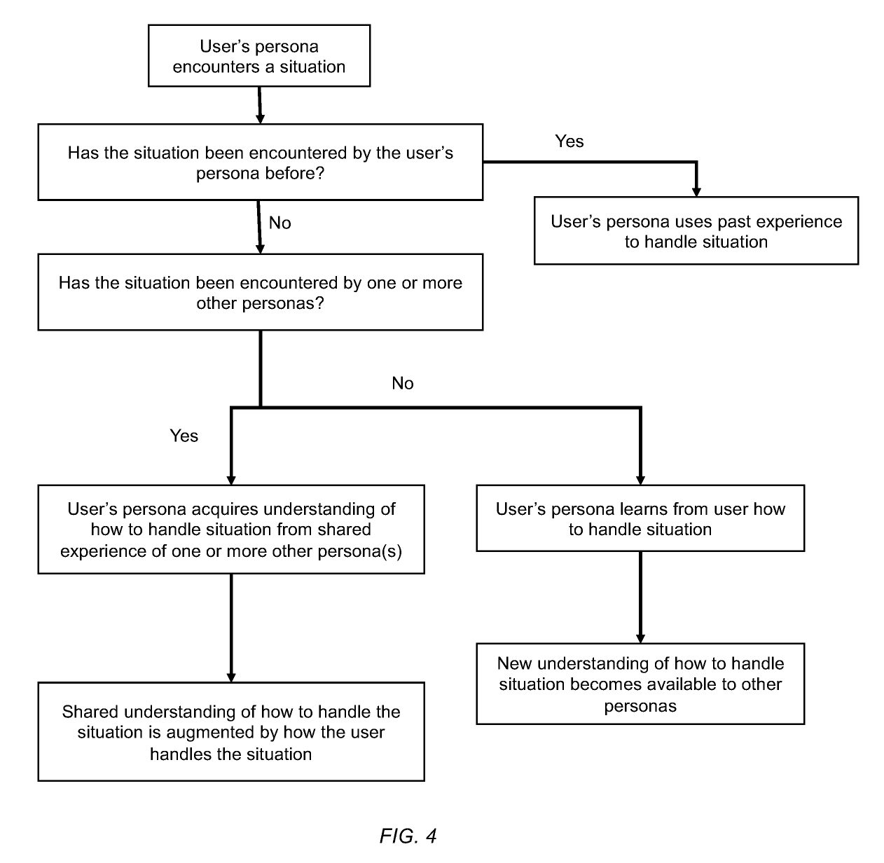

“Indirect” interactions are also contemplated. Indirect interactions come up when, for example, a user's persona encounters a situation that it has never encountered before. FIG. 4 shows an example of how these types of indirect interactions can take place. In the embodiment shown in FIG. 4, a user's persona first encounters a situation. The persona, at this stage, can either be user-controlled, or the persona can encounter the situation while the user (or the player in the context of game-based implementations of the inventive subject matter) is not actively controlling the persona (e.g., the user is disconnected from the persistent environment, or the user has stepped away from their computer, the persona is otherwise left without user input for whatever reason, etc.).

When a user's persona encounters a situation (e.g., a set of circumstances giving rise to a situation), it first determines whether it has encountered that situation before. If the situation has never been encountered before, then the persona checks if any other personas in the persistent environment have encountered that situation before either. If other personas have encountered that situation before, then the user's persona acquires an understanding of how to handle the situation from the shared experiences of any other persona(s) that have also encountered that situation. Then, as the user's persona handles the situation, it “learns” (described in greater detail below) from its experience, adding to the collective knowledge of all personas in the persistent environment (e.g., other personas that encounter similar situations can subsequently access the user's persona's newfound understanding of how to handle that situation). Thus, if the same situation is encountered again, then, as shown in the first branch of FIG. 4, the user's persona uses its past experience (and therefore the past experiences of all other personas in the persistent environment that have encountered that same situation) to handle the situation.

But if the situation encountered is completely new (e.g., new to both the user's persona and new to all other persona's in the persistent environment), the user's persona will have to handle the situation for the first time. Thus, by monitoring the user's interaction with their persona in handling the new situation, a new understanding of how to handle that situation is developed and made accessible other personas in the persistent environment. For example, a user can be using their persona as a personal digital assistant. When a user gives their persona text-based or speech-based instruction, the persona can interpret the instruction before undertaking an action and also query a persona database to determine how best to interpret the instruction based on how other personas have interpreted the same or similar instructions. Thus, every time an instruction is given to a persona of the inventive subject matter, all personas in a system of the inventive subject matter can benefit from the persona's handling of the instruction. User feedback can help determine whether an instruction has been handled properly.

Each user's persona is constantly learning. FIG. 5 is a flow chart showing an example of how users' personas can learn. After a user has created a persona, the user's persona can develop new understandings of the world by, for example, answering in game questions or quizzes, or the user can merely interact with the persona in the persistent environment (e.g., pathfinding or interacting with objects within the environment). As the user uses their persona to navigate the persistent environment, encountering new situations and other personas, the user's persona actively learns new behaviors and how to handle new situations.

For a persona to “learn,” several different computer learning techniques are contemplated. For example, a deep neural network can be implemented in implementations of the inventive subject matter to facilitate “learning” by the various personas that are active in a persistent environment. As described above, learning occurs through user-interaction with a persona, and it also occurs when a user's persona interacts with other personas in response to a new situation. Learning can also occur through interaction with aspects of a persistent environment. For example, if a user's persona exists within a virtual game environment, it can run into problems related to pathfinding, behaviors of personas in interactions with objects in the game, etc.

It is contemplated that, in some embodiments, a persona can become customized to its user through, e.g., machine learning. For example, as a user uses their persona to interact with personas and objects in the persistent environment, that user's persona learns the user's preferences over time. In this way, the user's persona can become a reflection of the user's self so that when the user stops using or interacting with their persona (e.g., the user logs out of a game, locks their phone, or otherwise ceases to give their persona input or guidance), the user's persona still exhibits behaviors that it learned from its user and from interactions and situations that its user exposed it to. In another example, as a user communicates with a persona (e.g., orally or in writing) that exists within a persistent environment, the user's persona, via a machine learning backend, learns its user's speech patterns and mannerisms, and then implements those patterns and mannerisms as its own to imitate the user.

In some embodiments, personas can learn from their users' digital footprints. It is contemplated that personas can use information like internet browsing history, gaming history, writing style, social media presence and interactions, and so on to learn and adapt to new situations and interactions.

Thus, each persona can be a reflection of its user—in behavior, interactions with objects, speech, purchasing decisions, etc. It is also contemplated that embodiments of the inventive subject matter solve problems related to low population of users in a game (e.g., during non-peak hours) by including personas that represent other users in a game world, even when those other users are not actively controlling those personas. One advantage of implementations of the inventive subject matter is that even the personas that are not actively user-controlled still exhibit the behaviors of their users, as described above, increasing immersiveness and creating the illusion of a world that is more populated than it actually is.

Embodiments of the inventive subject matter can also be implemented in the fields of e-commerce (e.g., bots to facilitate sales and new client intake), virtual and augmented reality, and Internet of Things devices and software networks, chat services, smart speakers, and so on. For example, a persona can be implemented as a chat bot to assist with sales on e-commerce websites, or a persona can be implemented as an assistant to a smart refrigerator. In all of these sorts of applications there exists a need for persistent personas that learn from both their users and from other personas that exist in the same persistent environment. For example, if a smart refrigerator detects that it is out of milk, but has never encountered this before, a persona could discover—using the shared experiences of other personas associated with that or other refrigerators—where to purchase more milk and then tell its user that the milk is gone and where more can be purchased. In some embodiments, the determination that more milk is needed can be learned from one subset of personas, while the determination of where to purchase that milk can be learned from another subset of personas, where those subsets can have overlapping members.

It is additionally contemplated that, once a persona has been developed in a particular environment, that persona can be transferred to other environments. For example, if a user engages in a simulation game (e.g., a game like the Sims), that user will develop their persona in the context of that game. But if the user then begins using another application in which a persona can be implemented, instead of creating an entirely new persona, that user can use the persona they have already developed as a starting point in that new environment.

Several examples of implementations of the inventive subject matter follow. In one example, a user plays a game using a persona as an in-game character, and the inventive subject matter is implemented so that the persona automatically learns and constructs a persona based on the user's behavior. Within the game's world, the user's persona is fully autonomous and persistent (e.g., the game world persists, and the user's persona exists within that game world, even when the user logs out or otherwise ceases to play the game).

In this embodiment, even when users are offline, those users' personas continue learning and interacting with other personas within the persistent game world. Each user can thus create personal, persistent, autonomous, intelligent personas without prior training since each new persona undergoes training and learning corresponding to its and other personas' experiences.

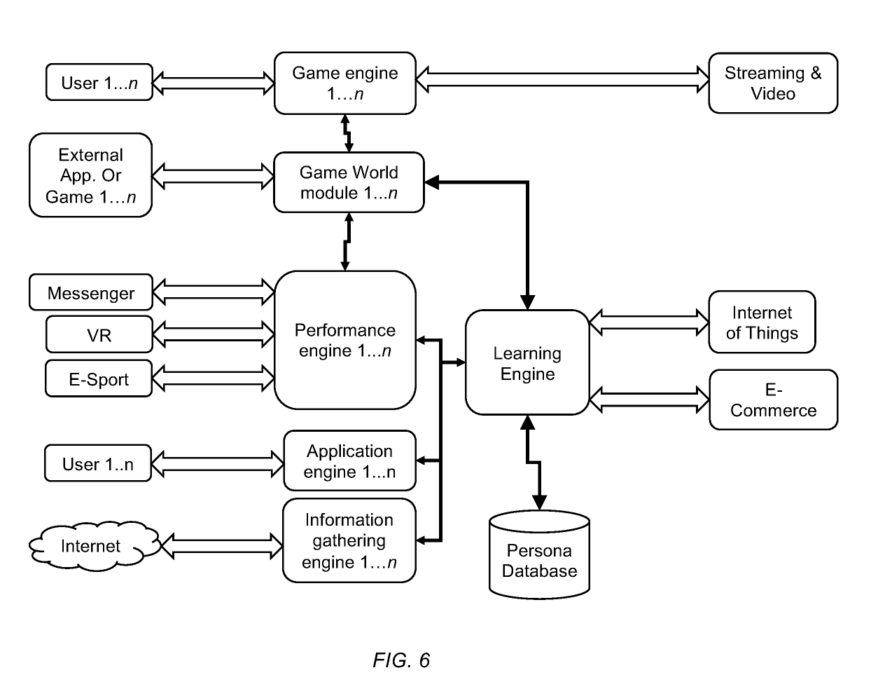

FIG. 6 shows how embodiments of the inventive subject matter can interact with a wide variety of different services, platforms, devices, and the Internet at large. Broadly, one or more users (e.g., a set of 1 . . . n users) interact with a game engine that is specific to each user (e.g., game engine 1 . . . n). The game engine, in turn is configured to communicate with a corresponding game world module (e.g., game world module 1 . . . n by running/rendering the game world according the corresponding game engine's parameters, where a game world module runs a game world) and the learning engine. The game engine, game world, and learning engine can all be run locally on a user's computer, but in some embodiments, it is contemplated that any combination of a user's computer and remote computers (e.g., servers or other network-enabled computing devices) can be implemented to run those aspects of the inventive subject matter.

When a developer makes a game, that game enables players to interact and play within a virtual world—i.e., players play the game within the virtual world. During play (and, in some embodiments, also while players are logged off or otherwise not interacting with the game), the learning engine analyzes each persona's actions (e.g., the actions of each persona as directed by a user) in the world and stores the result about the undertaken action in the persona database. In some embodiments, other information about the undertaken action can also be stored. For example, the persona's location, orientation, movements, inputs, and environmental information such as current in-game weather, proximity of other users, etc. can also be stored to the persona database to give additional context to the factors that led to a particular result. It is contemplated that personas and all associated information (learnings, behaviors, etc.) are stored in the persona database.

The learning engine can also be configured to guide persona behaviors. Behaviors can include, for example, interaction of a persona with other users or personas via text or speech, persona action animations, persona sound making that can be dependent on an encountered situation, how a persona moves within the virtual world in which it exists, etc. It is contemplated that persona behaviors that are stored in or developed by the learning engine can be implemented in the course of user-initiated interactions (e.g., when a persona takes an action according to user input) or in the course of persona-initiated interactions (e.g., when a persona that is not controlled by a user takes an action).

Different engines can be responsible for different actions. For example, the performance engine can be responsible for determining when a persona should communicate (e.g., via text or speech) with other personas or users. The performance engine can also be responsible for determining how a persona should be animated during, for example, interactions with other personas or with the game world based on the configuration of the persona's developed personality and the circumstances giving rise to the communication. Because the performance engine communicates directly with the learning engine, information about any new interaction (e.g., any new communication or animation) can be passed to the learning engine so that it can help guide that persona's (and others via persona-to-persona learning) future actions and interactions. Moreover, each newly encountered interaction can be viewed through the lens of a persona's past experience(s) as gathered and learned from via the learning engine and stored to the persona database.

The learning engine is configured to communicate with, for example, the persona database as well as with the performance engine, the application engine, and the information gathering engine. Thus, when a user logs into a game and accesses the game world, they are granted access to their persona that is stored in the persona database. As that user interacts with the game world, their persona is constantly learning via the learning engine (e.g., every interaction and action undertaken by each persona is run through the learning engine).

It is contemplated that the learning engine, as mentioned above, can be configured to implement a wide variety of machine learning tools. The learning engine can implement one or more of: Linear Regression, Logistic Regression, Decision Tree, SVM, Naive Bayes, kNN, K-Means, Random Forest, Dimensionality Reduction, Algorithms, Gradient Boosting algorithms, GBM, XGBoost, LightGBM, and CatBoost. In some embodiments, the learning engine additionally or alternatively implements evolutionary computing techniques.

In some embodiments, the learning engine can implement a user action matrix. A user action matrix includes a variety of possible user actions, but it is dimensionally smaller than a full matrix of all possible user actions. Reduced dimensionality improves machine learning performance by reducing the number of variables that can be considered.

An intuitive example of dimensionality reduction can be discussed in terms of e-mail classification, where e-mails must be classified as either spam or not spam. This can involve a large number of features, such as whether or not the e-mail has a generic title, the content of the e-mail, whether the e-mail uses a template, etc. But some of these features may overlap, which means some can be removed, thus reducing dimensionality. In another condition, a classification problem that relies on both humidity and rainfall can be collapsed into just one underlying feature, since both of the aforementioned are correlated to a high degree. Hence, we can reduce the number of features in such problems.

Reduced dimensionality can help in data compression, thereby reducing required storage space, it can reduce computation time, and it can help to remove redundant features, if any. This allows the learning engine account for a subset of the total possible features of a user action, which improves learning abilities of systems and methods of the inventive subject matter. Maintaining user action matrices can thus allow personas to persist in a virtual world even after a user has ceased to control that persona (e.g., by logging off) because each persona in the persistent world can access all user action matrices, thus giving each persona access to all possible learned behaviors.

Each persona stored in the persona database, once accessed by a user, experiences everything that the user puts it through via the learning engine. Moreover, in embodiments where personas exist within a persistent environment, even personas that are not actively being controlled by users (e.g., a user has logged off or is not actively controlling a persona) are nevertheless able to gather new information and experiences via the learning engine, since personas continue interacting with other personas and with the persistent environment in which they exist.

As each user uses a persona to interacts with a game world via a game engine (e.g., each user interacts with a locally running game world and game engine, thus user n interacts with game world n via game engine n), the learning engine exchanges information between itself and the performance engine, the application engine and the information gathering engine. Separate instances of the performance engine, the application engine, and the information gathering engine can be run on a per-user basis. For example, if user n is playing a game, that user will be playing using game engine n, game world n, performance engine n, application engine n, and information gathering engine n. It is contemplated that anyone or combination of these engines can be run locally (e.g., on a user's computer) or remotely (e.g., on a remotely accessed computer such as a server).

It is also contemplated that a single game (e.g., game n) can grant users access to multiple different game worlds (e.g., game worlds n+/−m), or in some embodiments, multiple different games (e.g., games n+/−m) can access the same game world (e.g., game world n).

Games are not the only potential uses for embodiments of the inventive subject matter. Systems and methods described in this application can similarly be useful for non-game applications. For example, embodiments of the inventive subject matter can be implemented in the areas of shopping or home appliance mobile software applications. It is contemplated that third-party applications can also access insights into personas via, for example, APIs.

In some embodiments, as shown in FIG. 6, the information gathering engine collects information relevant to a user's persona from the internet (or other internet-related data sources), and it then uses that information (e.g., gives the information to the learning engine) to improve or modify that user's persona according to the information it gathered. For example, in some embodiments, the information gathering engine is granted access (e.g., explicitly and by the user) to the user's web browsing history. Browsing history can be used to improve the persona's ability to suggest websites that the user would enjoy, or it can be used to teach a persona about a user's hobbies. Information gathered from the internet about a user can help improve a persona's decision-making as it applies to a user controlling that persona.

In some embodiments, a game engine, as shown in FIG. 6, can be used to in associating with video capture and streaming. For example, a user can stream video of their persona by requesting that their persona begin a livestream. The request can be received at a user's computer orally, by text, or by any other form of input (e.g., pressing a UI button), and the request is then interpreted by the performance engine and via the user's persona. In one example, if the persona has been asked to begin a livestream in the past using Twitch, then the persona, having learned the user's preference for Twitch, can begin the next livestream using that same service. Thus, the persona interprets the request in view of past experience and knowledge. Similarly, if the persona has never received a request to begin a livestream before, then it can use accumulated knowledge of other personas in the database (e.g., it can learn from other personas) to determine the most popular streaming services, and then give the user a suggestion for a streaming service to use.

Moreover, it is contemplated that personas can be streamed 24/7, whether or not a user is actively controlling the persona and even whether or not the user is logged in to use the persona at all. Because it is contemplated that personas can exist in a persistent virtual world where they continue to interact with the world and other personas even without a user controlling the persona, embodiments of the inventive subject matter facilitate games that can stream 24/7. Streaming, which is typically human-managed in real time and naturally cannot be done when a user if offline, is thus unconstrained by embodiments of the inventive subject matter. As shown in FIG. 6, content can be streamed via the game engine, although it is contemplated that other aspects of the inventive subject matter (e.g., other engines as shown in FIG. 6) can be used in the course of streaming as well.

In another aspect of the inventive subject matter, it is contemplated that personas, via the learning engine, can interact with devices that are part of the “internet of things” (e.g., smart refrigerators, smart thermostats, smart lights, etc.), as can be seen in FIG. 6. A user can thus use their persona to control various smart appliances. The personas learn users' preferences for things like when to turn the lights on, what temperature to set the refrigerator and freezer to, when to turn down the thermostat, and so on, all based on each user's personal preferences as learned by the invention. Each user's persona can learn both from their controlling user and also from other personas within the persona database how best to operate various smart appliances and other Internet of Things devices.

In some embodiments, personas can act on behalf of users in the course of conducting e-commerce. For example, a user can direct their persona to act on their behalf on an E-Commerce web site by asking their persona to recommend clothes on an online clothing site (e.g., Zara, Nordstrom, etc.). A persona can develop suggestions based on what it has learned about its user from, for example, the user's browsing history, the user's conversations that take place through the persona, etc. It is contemplated that the user can give their persona such a request orally or by text input. As shown in FIG. 6, e-commerce-related requests are routed through the learning engine so that the user's persona can use past learning in the course of fulfilling each request, and also so that each request and response can be learned from. For example, when a user receives a response comprising a list of recommended items, the user can indicate which items they like the most, thereby helping their persona learn their preferences.

It is also contemplated that personas can be used to create chatbots. As shown in FIG. 6, chatbots are operated by the performance engine. Chatbots can be useful to facilitate such activities as e-commerce by, for example, giving website visitors a place to ask questions, make appointments, or otherwise learn more about a business. In some embodiments, a user creates a chatbot based on a persona they have created and cultivated. The chatbot can be created by a request from a user, where that request is processed by systems of the inventive subject matter as shown in FIG. 6. Once a chatbot is created, it can then be implemented according to the user's instruction. For example, a chatbot can be instructed to function within a messaging service, e.g., Facebook Messenger, Skype, etc.

Embodiments of the inventive subject matter can additionally or alternatively be used in the field of virtual reality. As shown in FIG. 6, the performance engine can interface with virtual reality (VR) systems so people can use their personas within a VR environment. It is contemplated that personas can interact with objects or other personas in a full 3DVR environment. Embodiments of the inventive subject matter make it possible for personas to perform in a fully articulated 3D world with animation and other 3D space ability. As mentioned above, personas are configured to learn via the learning engine, and so, for example, personas' animations while navigating a 3D space can constantly be evolving according to what the personas within a system of the inventive subject matter learn about navigating a 3D world.

Embodiments of the inventive subject matter can also be used in association with e-sports. For example, a user can compete in competitive e-sports using a persona of the inventive subject matter. The user's persona can interact with the e-sport game via the performance engine, as shown in FIG. 6.

In other embodiments, users' personas can be used in non-game computer applications. For example, a user's persona can learn the user's writing style and provide suggestions within word processing applications. As shown in FIG. 6, the application engine facilitates cross-application support for personas of the inventive subject matter, which allows a user's personalized persona to bring a user's personal settings into different applications.

In other embodiments, users' personas can be used across a variety of different third-party games. As shown in FIG. 6, personas are enabled to operate within third-party games via the game world module. A user can thus use their persona (where the persona has learned the user's personal preferences) across multiple third-party applications or games.

Thus, specific systems and methods of improving online gaming interactivity have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A computer system for developing an avatar for a user, comprising:
a server configured to:
operate a persistent game world in which avatars can exist and interact;
maintain an avatar database that stores the avatar and learned avatar behaviors;
operate a learning engine, wherein the persistent game world, the avatar database, and the learning engine are informationally coupled;
accept network connections, wherein, when a network connection is established with a computing device associated with the user and upon establishing the network connection the user is given access to the avatar that is stored in the avatar database;
via the learning engine, learn an avatar behavior using information related to at least one action of the user when the user encounters a situation within the persistent game world;
update the avatar database to include the avatar behavior; and
after the user terminates the network connection, autonomously operate the avatar within the persistent game world using the avatar behavior.

2. The system of claim 1, wherein the at least one action of the user within the persistent game world comprises at least one of text-based and voice-based chat with other users' avatars.

3. The system of claim 2, wherein the avatar behavior comprises a speech pattern of the user.

4. The system of claim 1, wherein the at least one action of the user within the persistent game world comprises avatar pathfinding.

5. The system of claim 4, wherein the avatar behavior comprises a user's pathfinding preference.

6. The system of claim 1, wherein the server is further configured to:
query the avatar database when a second user in control of a second avatar encounters a similar situation to the situation that led to the avatar behavior being learned; and
allow the second avatar to use the avatar behavior.

7. A system for enabling virtual persistence of user avatars in an online environment comprising:
a server configured to:
accept a network connection from a computing device associated with a user;
authenticate the user;
send a network communication to the computing device indicating an association between the user and an avatar;
receive a network communication from the computing device associated with a user-directed action of the avatar;
operate a learning engine wherein the user-directed action of the avatar is used to modify a user action matrix for the avatar, wherein the user action matrix is dimensionally smaller than the set of possible user actions; and
imitate the avatar using the user action matrix for the avatar when the user is logged out.

8. The system of claim 7, wherein the user-directed action of the avatar is stored by the server after the user action matrix is modified using the user-directed action, thereby enabling re-processing of the user action matrix by the learning engine using the user-directed action.

9. The system of claim 7, wherein the user-directed action of the avatar is discarded by the server after the user action matrix is modified using the user-directed action.

10. The system of claim 7, wherein the user-directed action of the avatar comprises a movement path.

11. The system of claim 7, wherein the learning engine comprises a pre-processing step, wherein the pre-processing step transforms the user-directed action into pre-processed data before modifying the user action matrix using the pre-processed data.

12. The system of claim 11, further comprising the steps of:
querying the avatar database when a second user in control of a second avatar encounters a similar situation to the situation that led to the avatar behavior being learned; and
allowing the second avatar to use the avatar behavior.

13. A method of developing a personal assistant that is unique to a user, comprising:
using at least one server to operate a persistent virtual environment in which personal assistants can exist and interact;
storing a personal assistant database on the server, wherein the personal assistant database stores the personal assistant and learned personal assistant behaviors;
operating a learning engine, wherein the persistent virtual environment, the personal assistant database, and the learning engine are informationally coupled;
establishing, by the at least one server, a network connection with a computing device controlled by the user, wherein the user is given access to the personal assistant that is stored in the personal assistant database;
learning, via the learning engine, a personal assistant behavior using information related to at least one action of the user;
updating the personal assistant database to include the personal assistant behavior; and
using at least the personal assistant behavior to autonomously operate the personal assistant within the persistent virtual environment after the user terminates the network connection.

14. The method of claim 13, wherein the at least one action of the user within the persistent virtual environment comprises an instruction from the user to the personal assistant.

15. The method of claim 14, wherein the personal assistant behavior comprises a response to the instruction.

16. The method of claim 13, wherein the at least one action of the user within the persistent virtual environment comprises talking to the personal assistant.

17. The method of claim 16, wherein the personal assistant behavior comprises a user's speech patterns.

18. The method of claim 13, further comprising the steps of:
querying the personal assistant database when a second user in control of a second personal assistant encounters a similar situation to the situation that led to the personal assistant behavior being learned; and
allowing the second personal assistant to use the personal assistant behavior.
